(19) United States
(12) Patent Application Publication
(10) Pub. No.: US 2011/0067920 A1
(43) Pub. Date: Mar. 24, 2011

(54) Wiring harness having protection member

(75) Inventors: Eiichi Toyama, Kosai (JP); Shigemitsu Kameda, Kosai (JP); Shigemi Hashizawa, Kosai (JP)

(73) Assignee: Yazaki Corporation, Tokyo (JP)

(21) Appl. No.: 12/923,490

(22) Filed: Sep. 23, 2010

(30) Foreign Application Priority Data
Sep. 24, 2009 (JP) JP2009-219181

(51) Int. Cl. H02G 3/04

(52) U.S. Cl. 174/72 A

(57) ABSTRACT

A wiring harness is arranged at a predetermined location in a vehicle such as an automobile. The wiring harness comprises a plurality of electrical wires and a protection member in which to-be-protected portion of the electrical wires is inserted en bloc to be protected thereby. The protection member includes a plurality of main protection members serving as a principal part of the protection member for protecting the electrical wires and a plurality of secondary protection members serving as a secondary part with respect to the principal part, the main protection member being a corrugated tube and the secondary protection member being a standardized pipe.

### CROSS REFERENCE TO RELATED APPLICATIONS

This application claims priority to Japanese Patent Application No. 2009-219181 filed on Sep. 24, 2009, the contents of which are fully incorporated herein by reference.

### BACKGROUND OF THE INVENTION

1. Field of the Invention

The present invention relates to a wiring harness comprising a plurality of electrical wires and a protection member in which a to-be-protected portion of the electrical wires are inserted to be protected by the protection member.

2. Description of the Related Art

A wiring harness is arranged in a vehicle such as an automobile in such a state that it is arranged along a path that is bent in a complex pattern. Japanese Patent Application Laid-Open Publication No. 2005-80380 discloses a conventional wiring harness that comprises a plurality of electrical wires each having a terminal at an end thereof, and a plurality of protectors made of synthetic resin. The electrical wires are accommodated in and protected by various types of the protectors whose dimensions vary according to positions of arrangement. These protectors are protection members each adapted to protect more than one electrical wire en bloc and having various dimensions.

In the case of the above conventional wiring harness, it is necessary to design the protectors with various dimensions depending upon the positions of arrangement, and accordingly the design has to be provided on a per-vehicle basis, which considerably increases man-hours for the design process.

In addition, the above-described conventional protectors are a component dedicated to the specific vehicle in which the wiring harness is arranged, making it difficult to horizontally expand the coverage of various vehicle types. This causes absence of versatility or general-purpose property of the wiring harnesses. Molding dies have to be prepared for each type, which is not compatible with reduction of the manufacturing costs.

The above drawbacks may also occur in a wiring harness arranged in a hybrid automobile and an electric automobile.

### SUMMARY OF THE INVENTION

In view of the above-identified situation, an object of the present invention is to provide a wiring harness whose protection member can be designed at a speed of design equivalent to that of the arrangement design, another object thereof being to increase versatility of the protection member, yet another object thereof being to provide a wiring harness that can be manufactured with reduced costs.

In order to attain the above objective, a wiring harness of the present invention comprises (a) a plurality of electrical wires and (b) a protection member in which a to-be-protected portion of the electrical wires is inserted together to be protected thereby.

The protection member includes (i) a main protection member serving as a principal part of the protection member and (ii) a secondary protection member serving as a secondary part of the protection member.

The secondary protection member has a shape different from that of the main protection member and is connected to the main protection member.

The secondary protection member is a standardized pipe.

With the construction and arrangement described above, the secondary protection member of the protection member of the wiring harness is provided as the standardized pipe. The main protection member and the standardized pipe as the secondary protection member are designed as a marketed product or as a component for common use in various types of vehicles. The protection member allows the wiring harness to be effectively and readily arranged with the main protection member provided as a corrugated tube, a twisted tube, or a rubber material (EPDM; ethylene propylene diene monomer rubber), or a sheet member. Since the secondary protection member is the standardized pipe, the protection member can exert higher protection feature than that of the corrugated tube. The standardized pipe as the secondary protection member allows the wiring harness to be partly held at several locations of arrangement.

The corrugated tube and the standardized pipe allow the protection member as such to be designed concurrently with, or at a speed equivalent to that of, the design of how the wiring harness is to be actually arranged in the vehicle. Also, it is possible to increase versatility or the general-purpose property of the protection member and thus reduce the manufacturing costs of the protection member and the wiring harness as such. The protection member of the present invention can have more improved protection performance by synergistic combination of the standardized pipe and the corrugated tube.

Preferably, the electrical wires are either shielded electrical wires having an electrically shielding property or covered together by a shielding member provided around the electrical wires, and the protection member does not have the electrically shielding property.

With the construction and arrangement described above, the structure of the protection member can be simplified by providing the electrically shielding property on the side of the electrical wires.

The protection member can be designed concurrently with, or at the speed equivalent to that of, the design of how the wiring harness is to be actually arranged in the vehicle even when the wiring harness has to have the electrically insulating property. Also, it is possible to increase versatility or the general-purpose property of the protection member and thus reduce the manufacturing costs of the protection member and the wiring harness as such.

Preferably, the electrical wires are the shielded electrical wires, the shielded electrical wires being high-voltage electrical wires for a hybrid automobile or an electric automobile.

With the construction and arrangement described above, a wiring harness for the hybrid automobile or the electric automobile can be constructed, which will contribute to reduction in the manufacturing costs of the wiring harnesses.

Preferably, the main protection member and the secondary protection member of the protection member are arranged such that the protection member is allowed to be arranged in an underfloor of the hybrid automobile or the electric automobile.

With the construction and arrangement described above, the wiring harness can be effectively arranged in the underfloor of the hybrid automobile or the electric automobile.

Preferably, the secondary protection member is made of metal or resin depending upon an usage environment.

With the construction and arrangement described above, it is possible to provide higher protection performance by the standardized pipe made of metal as the secondary protection member. It is also possible to use the protection member as a heat-resistant component that can be arranged near a heat source. Meanwhile, the standardized pipe made of synthetic resin as the secondary protection member will be more lightweight than the one made of metal. If there is no constraints due to the usage environment in the electric automobile, one could choose an inexpensive one.

Preferably, the secondary protection member further includes a securing member for securing the wiring harness.

With the construction and arrangement described above, the wiring harness can be secured via the secondary protection member, which provides an advantageous configuration for effectively and readily securing the wiring harness at locations within a vehicle.

Preferably, the main protection member and the secondary protection member are arranged such that the protection member in its entirety can be substantially wound or folded at a predetermined location.

With the construction and arrangement described above, it is possible to wind or fold the wiring harness that is yet to be arranged. Thus, it is made possible to minimize a space necessary for transportation of the wiring harnesses, and, as a result, more wiring harnesses can be more effectively and readily transported, which will also contribute to reduction in the manufacturing costs of the wiring harnesses.

Preferably, the main protection member is substantially circular or oval in cross section depending upon an usage environment.

When using the cross-sectionally circular corrugated tube having high versatility, it is possible to reduce the manufacturing costs of the wiring harnesses. Meanwhile, when using the cross-sectionally oval corrugated tube, it is possible to partly decrease the height of the wiring harness and thus provide a more low-profile wiring harnesses. It should be noted that the cross-sectionally oval corrugated tube is in use, it is preferable that the corrugated to be is connected to the cross-sectionally circular standardized pipe via a grommet or other rubber components.

### BRIEF DESCRIPTION OF THE DRAWINGS

The present invention is described in a preferred embodiment in the following description with reference to the drawings, in which like numbers represent the same or similar elements, as follows:

FIG. 1A illustrates a configuration of the protection member in a wiring harness according to a first embodiment of the present invention;

FIG. 1B illustrates connection between a corrugated tube as a main protection member and a standardized pipe as a secondary protection member;

FIG. 1C illustrates the connection between the corrugated tube as the main protection member and the standardized pipe as the secondary protection member;

FIG. 1D illustrates an end portion of the wiring harness of FIG. 1A;

FIG. 2 schematically illustrates a vehicle in which a wiring harness according to a second embodiment of the present invention is arranged;

FIG. 3A is an enlarged view (partially exploded) of an underfloor-type corrugated tube and a reinforcement element of FIG. 2 where an underfloor portion of a vehicle body is viewed from a ground surface;

FIG. 3B is a cross-sectional view of FIG. 3A taken along the line A-A in FIG. 3A;

FIG. 4A illustrates a flow from manufacturing of the wiring harness of FIG. 2 to mounting of the wiring harness to the vehicle where the wiring harness is shown as immediately after the manufacturing process;

FIG. 4B illustrates the wiring harness of FIG. 2 in a state where the wiring harness is received in a general-purpose returnable box and is transported;

FIG. 4C illustrates the wiring harness of FIG. 2 taken out of the returnable box prior to being mounted in the vehicle; and

FIG. 4D illustrates the wiring harness of FIG. 2 mounted to the vehicle.

### DESCRIPTION OF THE EXEMPLARY EMBODIMENT

A wiring harness of the present invention comprises a protection member into which all of to-be-protected portions of a plurality of electrical wires are inserted en bloc to be protected by the protection member, the protection member including a corrugated tube and a standardized pipe.

### First Embodiment

A first embodiment of the present invention is described with reference to the attached drawings.

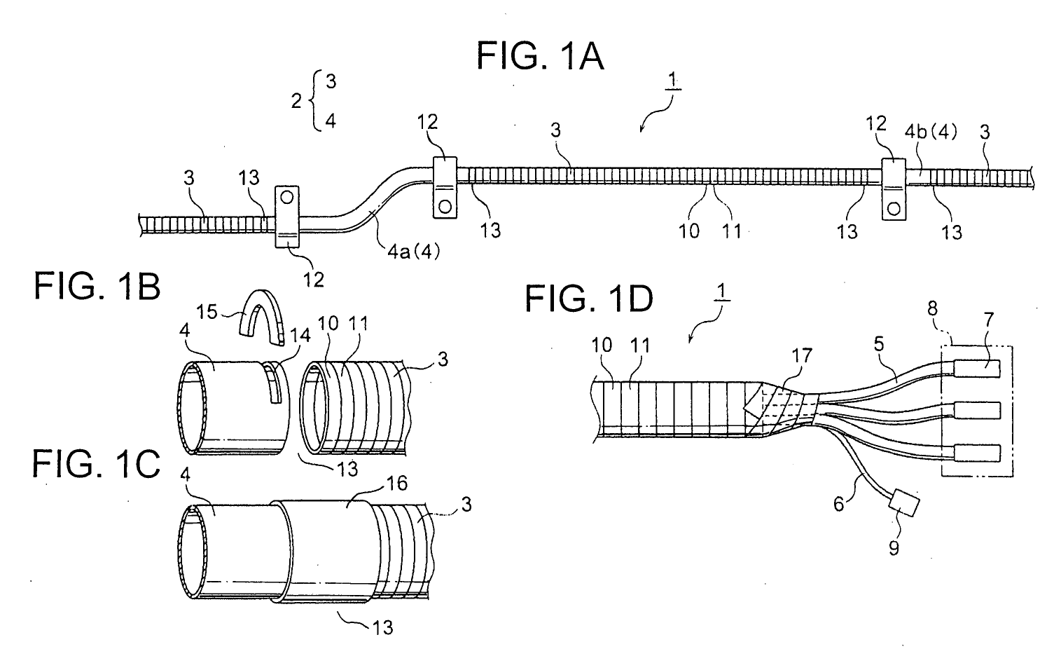

Referring to FIGS. 1A to 1D, there is shown a wiring harness according to the first embodiment of the present invention.

The wiring harness 1 illustrated in FIG. 1A is arranged at a predetermined location in a not-shown vehicle such as an automobile. The wiring harness 1 comprises (a) a plurality of electrical wires and (b) a protection member 2 in which a to-be-protected portion of the electrical wires are inserted en bloc to be protected by the same protection member 2.

The protection member 2 comprises (i) a plurality of main protection members (i.e., a corrugated tube 3, which will be described later) serving as a principal part of the protection member 2 for protecting the electrical wires and (ii) a plurality of secondary protection members (i.e., a standardized pipe 4, which will be described later) serving as a secondary part of the protection member 2.

Referring to FIG. 1D, the electrical wires of this embodiment include, but not limited to, a plurality of high-voltage electrical wires 5 and a low-voltage electrical wire 6. It should be noted that the configuration and the number of the electrical wires of FIG. 1D are illustrated by way of example. The electrical wires may solely be the low-voltage electrical wires 6 or the high-voltage electrical wires 5.

The high-voltage electrical wire 5 is a shielded electrical wire having an electrically shielding property and includes, but not limited to, an electrically conductive central conductor and a braided shielding member. A terminal 7 is connected to the central conductor at an end of the high-voltage electrical wire 5. The shielding member is connected to a ground part 8. The terminals 7 are each accommodated in and secured to an electrically insulating housing (not shown). The ground part 8 is provided on an outer portion of the housing.

The low-voltage electrical wire 6 has a connector 9 at an end thereof.

Portions of the high-voltage electrical wires 5 continuing to one ends to the other ends thereof and extending therebetween in a length direction of the high-voltage electrical wires 5 and the low-voltage electrical wire 6 are defined as the to-be-protected portion (the range of the to-be-protected portions is an exemplary one). If more than one to-be-protected portions are defined, the wiring harness 1 will include more than one protection member 2. The to-be-protected portion may be not only a mainline portion but also a branch line portion (this embodiment only describes the case of the mainline portion).

The protection member 2 includes the main protection members and the secondary protection members. The main protection member is, but not limited to, the corrugated tube 3. Alternatively, the main protection member may be a twisted tube, a rubber material (EPDM; ethylene propylene diene monomer rubber), or a sheet member. The secondary protection member is the standardized pipe 4 which has a shape different from that of the main protection member. The main protection member and the secondary protection member, i.e., the corrugated tube 3 and the standardized pipe 4, are those that are designed as a marketed product or as a component for common use in various types of vehicles.

The corrugated tube 3 is made of electrically insulating synthetic resin (having no shielding property) and is circular in cross section (or may have a non-circular cross section such as an oval one) and has a corrugated shape formed by raised portions 10 and valley portions 11 each formed in a circumferential direction of the corrugated tube 3 and alternately arranged in a length direction thereof. The corrugated tube 3 can be readily bent.

The standardized pipe 4 is circular in cross section and arranged between the corrugated tubes 3 (see FIG. 1A). Since the high-voltage electrical wires 5 are the shielded electrical wires, the standardized pipe 4 does not need to include an electrically shielding property.

The standardized pipe 4 is made of synthetic resin (if the standardized pipe 4 is arranged near a heat source and has to serve as a heat-resistant member, it may be made of metal).

The standardized pipe 4 can be bent in a subsequent process following a previous process in which the high-voltage electrical wires 5 and the low-voltage electrical wire 6 have been inserted in the standardized pipe 4 to be protected thereby. Alternatively, the standardized pipe 4 may be bent before inserting therein the high-voltage electrical wires 5 and low-voltage electrical wire 6.

The standardized pipe with the reference sign 4a out of the two standardized pipes 4 shown in FIG. 1A is bent twice to be substantially crank-shaped. The standardized pipe with the reference sign 4b extends straight. Bending of the standardized pipe may depend on arrangement paths of wiring harnesses.

The standardized pipe 4 may include a securing member 12. The securing member 12 of this embodiment is a clamp dedicated to pipes and includes a portion wound around an outer periphery of the standardized pipe 4 and a to-be-screwed portion which can be secured by a screw to a not-shown element on which the wiring harness 1 is to be arranged, the not-shown element being, but not limited to, a panel of a vehicle body and a reinforcement element. Alternatively, the securing member 12 may be a band or a clip element.

The securing member 12 of this embodiment is to be subsequently arranged. The arrangement and the number of the securing member 12 in FIG. 1A are illustrated by way of example. It is also possible that the standardized pipe 4 does not include the securing member 12. For example, the securing member 12 may be provided on the corrugated tube 3. Also, if the standardized pipe 4 is made of metal, the securing member 12 may be welded to the standardized pipe 4.

The corrugated tube 3 and the standardized pipe 4 have a standardized diameter. If more than one diameter is to be specified, then the most appropriate one can be selected depending upon modes of usage and usage environment.

The reference sign 13 indicates a connecting portion connecting the corrugated tube 3 to the standardized pipe 4. The connecting portion 13 is, but not limited to, connected in a manner as shown in FIGS. 1B and 1C.

Referring to FIG. 1B, a slit 14 is provided near an end face of the standardized pipe 4. The slit 14 is a notch formed in parallel with the end face. Also, a substantially U-shaped tube-connecting member 15 may be provided that is adapted to be brought into engagement with the slit 14. Specifically, the tube-connecting member 15 is adapted to be brought into engagement with the valley portion 11 of the corrugated tube 3 inserted in the standardized pipe 4 so that the corrugated tube 3 and the standardized pipe 4 are connected to each other.

Referring to FIG. 1C, the corrugated tube 3 and the standardized pipe 4 are connected to each other via a rubber component such as a grommet 16. The grommet 16 has a ring shape extending over both of the corrugated tube 3 and the standardized pipe 4 to connect them to each other. It is appreciated that the grommet 16 is effective in connecting the corrugated tube 3 having a shape different from that of the circular standardized pipe 4 (for example, an oval shape) to the standardized pipe 4.

Referring to FIG. 1D, the high-voltage electrical wires 5 and the low-voltage electrical wire 6 drawn out of the corrugated tube 3 is held by a wound tape 17. The wound tape 17 extends over the end of the corrugated tube 3 and the high-voltage electrical wires 5 and the low-voltage electrical wire 6.

When assembling the wiring harness 1 having the above-described configuration and structure, the high-voltage electrical wires 5 and the low-voltage electrical wire 6 are inserted en bloc in the protection member 2, the protection member 2 comprising the corrugated tube 3 and the standardized pipe 4. Thereafter, the standardized pipe 4a is bent twice to take the crank shape. The corrugated tube 3 of the wiring harness 1 is bent in accordance with the arrangement paths of the wiring harness 1, and the standardized pipe 4 is secured by a screw to a predetermined location, and thus the wiring harness 1 is arranged with respect to its intended location of arrangement (such as the vehicle body panel and the reinforcement element).

The wiring harness 1 according to the first embodiment of the present invention, the protection member 2 comprises the main protection member in the form of the corrugated tube 3 and the secondary protection member in the form of the standardized pipe 4. An advantageous effect of this configuration is that the corrugated tube 3 and the standardized pipe 4 allow the protection member 2 as such to be designed concurrently with, or at a speed equivalent to that of, the design of how the wiring harness is to be actually arranged in the vehicle.

In addition, another advantageous effect of the corrugated tube 3 and the standardized pipe 4 according to the first embodiment of the present invention is that it is possible to increase versatility or general-purpose property of the protection member 2 and thus reduce manufacturing costs of the protection member 2 and the wiring harness 1 as such.

### Second Embodiment

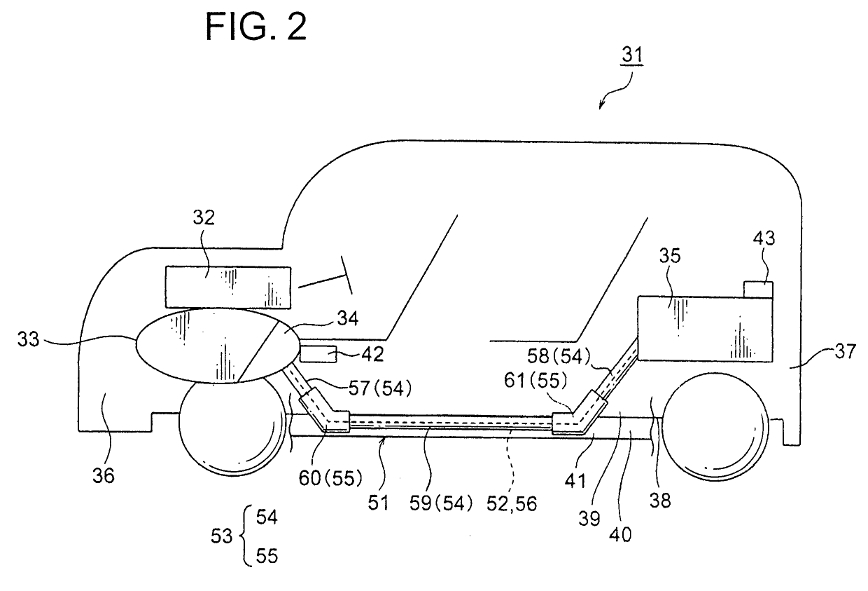

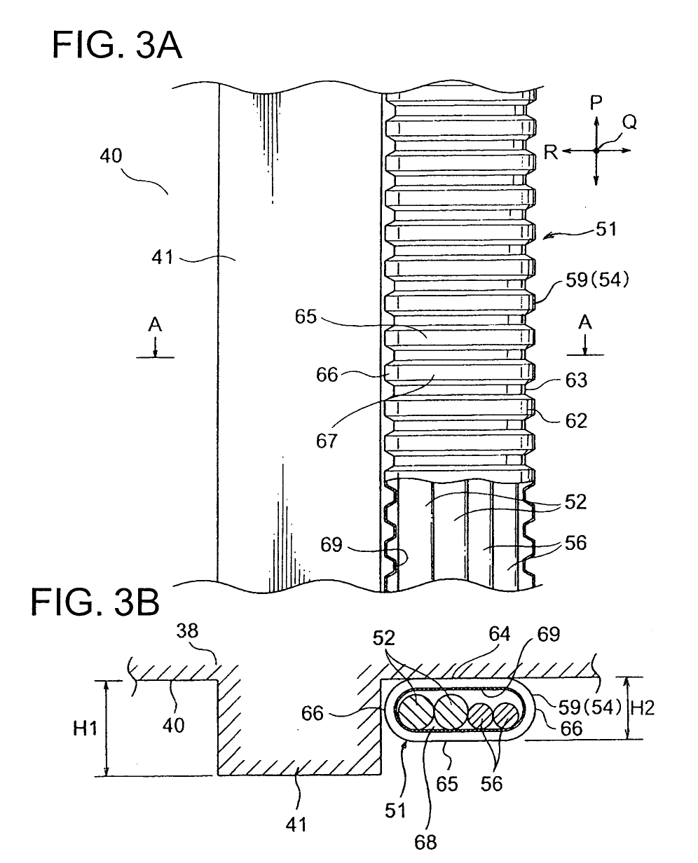

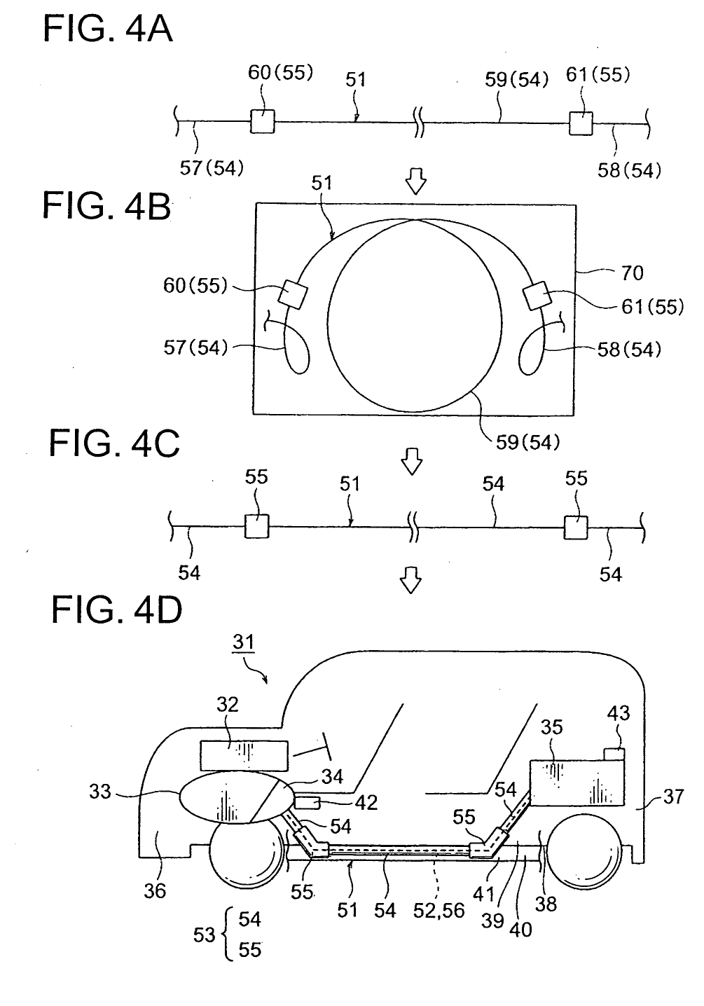

The following describes a second embodiment of the present invention with reference to the attached drawings. FIG. 2 schematically illustrates a vehicle in which the wiring harness of the present invention is arranged. FIG. 3 illustrates an underfloor-type corrugated tube for a floor and a reinforcement element shown in FIG. 2. FIG. 4 schematically illustrates a flow from manufacturing of the wiring harness of FIG. 2 up to arrangement of the wiring harness to a vehicle.

The wiring harness contemplated in the second embodiment is the one that is to be arranged in a hybrid automobile or an electric automobile. Although the following describes the second embodiment in the context of the hybrid automobile, it should be appreciated that the wiring harness of the present invention basically has the same configuration, structure, and advantageous effects even in the context of the electric automobile.

Referring to FIG. 2, the reference sign 31 indicates the hybrid automobile. The hybrid automobile 31 is a vehicle powered by combination of an engine 32 and a motor 33. The motor 33 is powered by a battery 35 via an inverter 34. The engine 32, motor 33, and the inverter 34 are mounted in a front portion 36 of the inner space of the vehicle where the front wheels are provided. Also, the battery 35 is mounted in a rear portion 37 of the inner space of the vehicle where the rear wheels are provided.

The reference sign 38 indicates a vehicle body frame. As shown in FIG. 2, an upper space 39 over the floor of the vehicle body is provided above the vehicle body frame 38. An underfloor 40 of the vehicle body is provided under the vehicle body frame 38. The underfloor 40 includes a cross-sectionally convex reinforcement element 41 that is adapted to increase strength of the vehicle. The reinforcement element 41 extends along a length of the vehicle. The reference sign 42 in the front portion 36 of the inner space of the vehicle indicates an electrical junction box such as a known relay box. Also, the reference sign 43 in the rear portion 37 of the inner space of the vehicle indicates a known low-voltage battery (the arrangement of the low-voltage battery 43 is not limited to the illustrated one).

In the second embodiment, the motor 33 comprises a motor and a generator. Also, the inverter 34 comprises an inverter and a converter. The inverter 34 is an inverter assembly in which the inverter may be an air conditioner inverter, an inverter for a generator, an inverter for the motor. The battery 35 may be modularized Ni-MH or Li-ion types. A capacitor or other capacitor component may be used. The battery 35 may be any type as long as it can be used in the hybrid automobile and the electric automobile.

The inverter 34 and the battery 35 are connected to each other via the wiring harness 51 of the present invention.

The wiring harness 51 according to the second embodiment of the present invention comprises (a) a plurality of high-voltage electrical wires 52 electrically connecting the inverter 34 to the battery 35 and (b) a corrugated tube 54 as a main protection member of the protection member 53 protecting the high-voltage electrical wires 52, and (c) a standardized pipe 55 as a secondary protection member of the protection member 53. Also, the wiring harness 51 in this embodiment may include a plurality of known low-voltage electrical wires 56. The low-voltage electrical wire 56 is provided in this embodiment in order to arrange the low-voltage battery 43 in the rear portion 37 of the vehicle's inner space. This embodiment contemplates modularization.

The wiring harness 51 extends from the front portion 36 of the vehicle's inner space, via the underfloor 40, and to the rear portion 37 of the vehicle's inner space. The wiring harness 51 is passed through the vehicle body frame 38.

The following describes the configuration of the wiring harness 51.

The high-voltage electrical wire 52 is a known power cable that is circular in cross section and has a predetermined diameter. The high-voltage electrical wire 52 is thicker than the low-voltage electrical wire 56, and a conductor residing at the center thereof is made of copper, copper alloy, or aluminum. Two high-voltage electrical wire 52 are provided in this embodiment, with a connector (not shown) having a terminal fitting for connection of devices provided at an end of each of the wires 52. The high-voltage electrical wire 52 may include braided construction and have an electrically shielding property. With regard to the electrically shielding property, there may be provided a shielding member (braided or metal foil) configured to cover en bloc the high-voltage electrical wires 52. The high-voltage electrical wire 52 may be a cabtire cable.

The low-voltage electrical wire 56 along with the high-voltage electrical wire 52 is protected by the protection member 53. An end of the low-voltage electrical wire 56 is connected to the electrical junction box 42 and the other end thereof to the low-voltage battery 43.

The protection member 53 for protecting the high-voltage electrical wires 52 and low-voltage electrical wires 56 comprises, as has been described in the foregoing, the corrugated tube 54 as the main protection member, and the standardized pipe 55 as the secondary protection member.

The corrugated tube 54 comprises vehicle-internal corrugated tubes 57, 58 serving as the main protection member in the vehicle's inner space, and an underfloor corrugated tube 59 serving as the main protection member in the underfloor 40. Meanwhile, the standardized pipe 55 comprises a front-side standardized pipe 60 residing between the vehicle-internal corrugated tube 57 and the underfloor corrugated tube 59, and a rear-side standardized pipe 61 residing between the vehicle-internal corrugated tube 58 and the underfloor corrugated tube 59. The front-side standardized pipe 60 and the rear-side standardized pipe 61 each include a securing member (not shown) for connecting the standardized pipes to the underfloor 40.

The vehicle-internal corrugated tubes 57, 58 are the main protection member positioned in the vehicle's inner space corresponding to the upper space 39 over the floor of the vehicle body, and are known corrugated tubes made of synthetic resin having the electrically insulating property and circular in cross section. It should be noted that the vehicle-internal corrugated tubes 57, 58 may have any cross-sectional shape other than the circular one as long as it can protect the high-voltage electrical wire 52 within the vehicle's inner space. The vehicle-internal corrugated tube 57 is arranged in the front portion 36 of the vehicle's inner space. The vehicle-internal corrugated tube 58 is arranged in the rear portion 37 of the vehicle's inner space.

Referring to FIGS. 2 and 3, the underfloor corrugated tube 59 is a flat tube made of synthetic resin having the electrically insulating property and non-circular cross section (an oval cross section is illustrated), and includes raised portions 62 and valley portions 63 that are independently provided in a circumferential direction of the tube 59 and alternately and continuously arranged along an axial direction of the tube 59 (see a direction indicated by an arrow P in FIG. 3) so as to be corrugated in shape. The underfloor corrugated tube 59 having this configuration can be readily bent in a Q direction vertical with respect to the drawing sheet containing FIG. 3, and a direction of bending is restricted so that the corrugated tube 59 is not readily bent in the direction indicated by an arrow R (a direction widthwise of the corrugated tube 59).

The shape of the corrugated tube 59 is described in more detail. The underfloor corrugated tube 59 includes a pair of flat surfaces opposed to each other and a pair of curved surfaces opposed to each other and connecting these two flat surfaces so as to be, but not limited to, oval in cross section. Specifically, the corrugated tube 59 includes an underfloor mounting surface 64 and an opposed-to-ground surface 65 and a pair of curved surfaces 66 so as to be oval in cross section. The raised portion 62 includes a top face 67 which will serve as the underfloor mounting surface 64, the opposed-to-ground surface 65, and the curved surface 66.

The reason why this specific shape is needed is as follows: A height H1 of the reinforcement element 41 (a height H1 from the underfloor 40 to the protruding end face of the reinforcement element 41) has to be larger than a height H2 of the underfloor corrugated tube 59. In other words, the underfloor corrugated tube 59 has to be low-profile relative to the reinforcement element 41. Second, an internal space 68 should be provided corresponding to a state where the high-voltage electrical wires 52 and the low-voltage electrical wires 56 are juxtaposedly and linearly arranged. The internal space 68 is provided such that a gap between the high-voltage electrical wire 52 and the internal surface 69 of the corrugated tube 51 is minimized in the state where the high-voltage electrical wires 52 and low-voltage electrical wires 56 are juxtaposedly and linearly arranged and accommodated therein (the gap can be adjusted within such a range that manufacturing is not affected). The underfloor corrugated tube 59, when arranged next to the reinforcement element 41, is adapted to be hidden in a dead space (not shown) provided by the reinforcement element 41.

The underfloor corrugated tube 59 is provided in a seamless manner along the axial direction of the tube 59 (see the direction indicated by the arrow P in FIG. 3) without any slit provided therein. The high-voltage electrical wires 52 and the low-voltage electrical wires 56 are inserted into the underfloor corrugated tube 59 from one opening thereof to the other opening thereof, respectively.

Referring again to FIG. 2, the front-side standardized pipe 60 and the rear-side standardized pipe 61, which are the secondary protection member and also the standardized pipe 55, are capable of holding the underfloor corrugated tube 59 in a state where the tube 59 extends along the underfloor 40. The front-side standardized pipe 60 and the rear-side standardized pipe 61 are circular in cross section. The front-side standardized pipe 60 and the rear-side standardized pipe 61 are made of synthetic resin (or they may be made of metal) and do not need to have the electrically shielding property because the high-voltage electrical wires 52 are the shielded electrical wires. The front-side standardized pipe 60 and the rear-side standardized pipe 61 can be bent in a subsequent process following a previous process in which the high-voltage electrical wires 52 and the low-voltage electrical wires 56 are inserted in the standardized pipes 60, 61 to be protected thereby. The arrangement and the number of the standardized pipe 55 are only illustrated by way of example.

The following describes manufacturing and assembling of the wiring harness 21 with reference to FIG. 4.

Referring to FIG. 4A, the front-side standardized pipe 60 is provided between the vehicle-internal corrugated tube 57 and the underfloor corrugated tube 59 to connect these two tubes to each other. Likewise, the rear-side standardized pipe 61 is provided between the vehicle-internal corrugated tube 58 and the underfloor corrugated tube 59 to connect these two tubes to each other. In this manner, the protection member 53 is provided.

Thereafter, the high-voltage electrical wires 52 and the low-voltage electrical wires 56 are inserted into and passed through the protection member 53. Further, the ends of the high-voltage electrical wires 52 and the low-voltage electrical wires 5 are exposed out of the vehicle-internal corrugated tubes 57, 58, and these exposed portions are treated as required (for example, providing connectors and terminal fittings thereto). In this manner, the manufacturing of the wiring harness 51 of the present invention is completed.

The wiring harness 51 after completion of manufacturing is then bent at the location of the underfloor corrugated tube 59 and at the position of the vehicle-internal corrugated tubes 57, 58, and wound as illustrated in FIG. 4B, and then accommodated in a returnable box 70. The wiring harness 51 accommodated in the returnable box 70 is transported to an assembly factory of an automobile manufacturer by a transport vehicle. In the assembly factory, the wiring harness 51 is taken out of the returnable box 70 prior to being mounted in the vehicle (see FIG. 4C). When the wiring harness 51 is mounted at a predetermined location in the vehicle, the arrangement process of the wiring harness 51 is completed.

As has been described in the foregoing with reference to FIGS. 2 to 4, an advantageous effect of the second embodiment of the present invention is that it is possible to provide the wiring harness 51 that can be effectively arranged under the floor of the hybrid automobile 31 (or the electric automobile). The second embodiment has another advantageous effect that the wiring harness 51 for the hybrid automobile 31 (or the electric automobile) contributes to reduction in manufacturing costs.

While the exemplary embodiments of the present invention have been described by way of example, it will be appreciated by those skilled in the art may make various modifications in the light of the above teaching and within the scope and sprit of the present invention, and the scope of the invention is to be defined by the claims appended hereto.

What is claimed is:

1. A wiring harness comprising:
(a) a plurality of electrical wires; and
(b) a protection member in which to-be-protected portions of the electrical wires are inserted together to be protected thereby, the protection member including (i) a main protection member serving as a principal part of the protection member and (ii) a secondary protection member serving as a secondary part of the protection member, the secondary protection member having a shape different from that of the main protection member and being connected to the main protection member, and the secondary protection member being a bendable standardized pipe.

2. The wiring harness as set forth in claim 1, wherein the electrical wires are either shielded electrical wires having an electrically shielding property or covered together by a shielding member provided around the electrical wires, and the protection member does not have the electrically shielding property.

3. The wiring harness as set forth in claim 2, wherein the electrical wires are the shielded electrical wires, the shielded electrical wires being high-voltage electrical wires for a hybrid automobile or an electric automobile.

4. The wiring harness as set forth in claim 3, wherein the main protection member and the secondary protection member of the protection member are arranged such that the protection member is allowed to be arranged in an underfloor of the hybrid automobile or the electric automobile.

5. The wiring harness as set forth in claim 1, wherein the secondary protection member is made of metal or resin depending upon an usage environment.

6. The wiring harness as set forth in claim 1, wherein the secondary protection member further includes a securing member for securing the wiring harness.

7. The wiring harness as set forth in claim 1, wherein the main protection member and the secondary protection member are arranged such that the protection member in its entirety can be substantially wound or folded at a predetermined location.

8. The wiring harness as set forth in claim 1, wherein the main protection member is substantially circular or oval in cross section depending upon an usage environment.
